(19) United States
(12) Patent Application Publication
(10) Pub. No.: US 2012/0198983 A1
(43) Pub. Date: Aug. 9, 2012

(54) Drum Head Adapter System for Musical Drums

(76) Inventor: Paul R. Wilson, Garden Grove, CA (US)

(21) Appl. No.: 13/368,323

(22) Filed: Feb. 7, 2012

Related U.S. Application Data
(60) Provisional application No. 61/462,772, filed on Feb. 8, 2011.

(51) Int. Cl. G10D 13/02

(52) U.S. Cl. 84/413

(57) ABSTRACT

A system for spacing structural members of a drum head of a drum apart from the drum shell, thereby eliminating a source of distortion to the tonal qualities of the drum. One or more adapting brackets having a series of inner and outer holes are provided. The bracket is fastened to the lugs of the drum shell using the inner holes. An oversize drum head is substituted for the conventional drum head.

### REFERENCE TO RELATED APPLICATION

This application claims priority benefit of Ser. No. 61/462,772, titled “Integrated Floating Drum Head Bracket”, filed Feb. 8, 2011.

### FIELD OF THE INVENTION

The present invention relates to musical percussion instruments, and more particularly to drums wherein drum heads of diameter different from those of conventional relationship to the drum shell are accommodated.

### BACKGROUND OF THE INVENTION

Musical drums are percussion instruments wherein sound is generated by striking a tightly stretched web supported on an annular drum shell. Conventional drums comprise three significant components, including the annular shell, an upper drum head, and a lower drum head. The upper drum head provides a first tightly stretched web which contacts the drum shell and is anchored to the drum by structure which is just outside the drum shell.

A drum is a musical instrument. Therefore, as with all musical instruments, sound qualities are important. Precise tonal qualities of the sound of a drum may be modified by the user to a limited degree by adjusting tension of the drum head relative to the shell. However, due to the way contemporary drums are constructed, sound qualities are slightly degraded by incidental contact between the shell and the drum head. There remains a need in the art to reduce degradation of sound qualities of drums arising from conventional construction of drums.

### SUMMARY OF THE INVENTION

The present invention addresses the above stated need by eliminating some of the incidental contact of the shell with other components of a conventional drum. This may be accomplished by providing an adapting bracket system which spaces the connective components associated with the drum head from the drum shell. One or more adapting brackets are fastened to conventional lugs provided as part of the shell. These lugs are conventionally used to receive tension keys which draw the hoop or rim of the drum head towards and away from the lugs. The closer the hoop is drawn toward the lugs, the greater the tension on the web of the drum head.

In the present invention, the screw hole pattern which receives the tension keys is spaced radially away from the center line or axis of the annular drum shell. This requires that a new drum head of greater nominal diameter or size be provided. However, this substitution eliminates deleterious contact between the shell and the components associated with the drum head, thereby improving audible tones produced by playing the drum.

Obtaining the new drum head is easily accommodated since drum heads are produced in many sizes, widely stocked in music retail outlets, and thus are readily commercially available.

The new drum head may be subjected to conventional tension adjustment, only with the tension keys being threaded into the adapting bracket rather than into the lugs as is conventionally performed.

It is an object of the invention to improve the tonal qualities of drums by eliminating incidental contact between the shell and those components of the drum associated with the drum head.

Another object of the invention is to minimize use of novel components and otherwise mitigate costs of converting standard drums into drums displaying improved tonal qualities.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1A is a simplified exploded perspective view of a drum.

FIG. 1B is a diagrammatic exploded top plan view of a drum shell and several novel adapting brackets.

FIG. 2 is a diagrammatic top plan view corresponding to FIG. 1, but showing the adapting brackets in the position they would assume when assembled to the drum shell.

FIG. 3 is a diagrammatic perspective view of one of the adapting brackets seen in FIG. 1, drawn to enlarged scale.

FIG. 4 is a diagrammatic perspective view of an alternative form of an adapting bracket.

FIG. 5 is a diagrammatic detail side view of a drum fitted with the novel adapting brackets, shown partially in cross section, and drawn to enlarged scale.

FIG. 6 is a diagrammatic side detail view of a prior art drum, shown partially in cross section, and drawn to enlarged scale.

### DETAILED DESCRIPTION

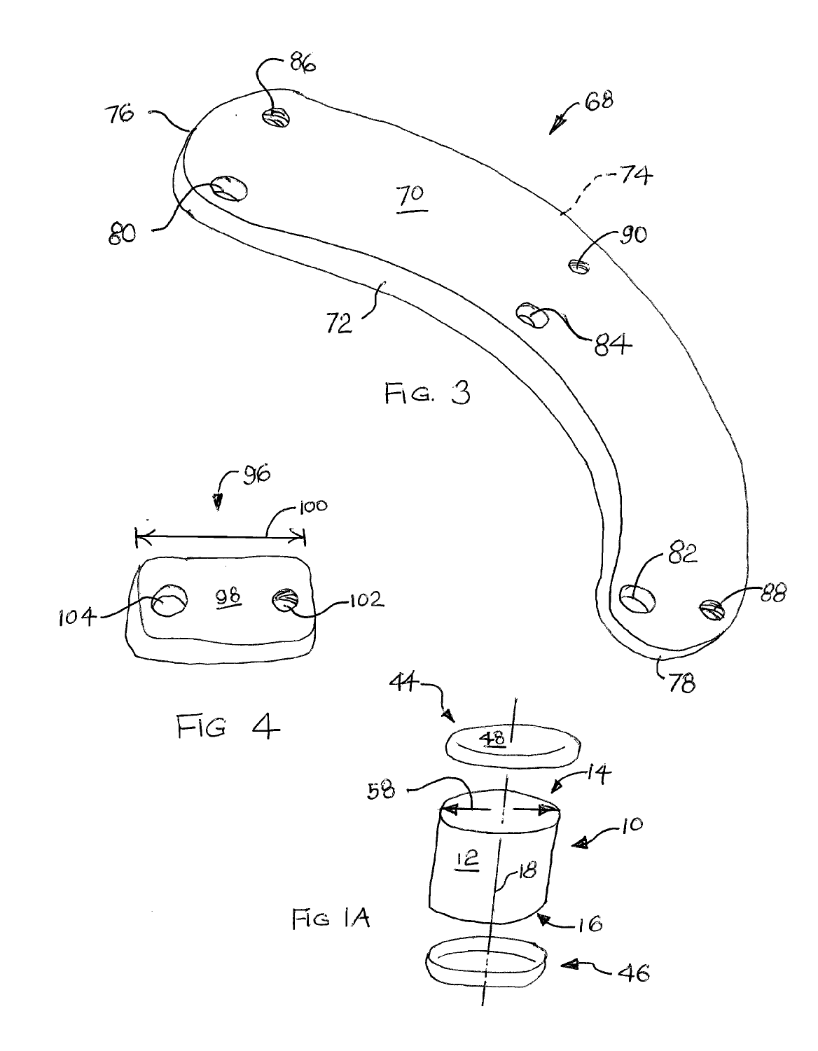

FIG. 1A shows an annular drum shell 10 of a musical drum (not shown in its entirety), which is seen to comprise an annular wall 12, a first open end 14, and an opposed second open end 16. An axis 18 extends from the first open end 14 to the opposed second open end 16, and is oriented concentrically within the annular wall 12. A first drum head 44 and a second drum head 46 (shown only representatively, without realistic detail) may be provided with a skin or web 48 (shown only for the drum head 44, it being understood that the drum head 46 may be of similar, mirror image construction) having functional characteristics of the first drum head, which may be dimensioned and configured to close the second open end 16 of the drum shell 10, and may provide a second striking surface or a sound modifying surface, which is mountable to the shell 10.

To provide necessary acoustic qualities as a percussion instrument, the web 48 is dimensioned and configured to close the first open end 14 and to be drawn tightly into abutment with the annular drum shell 10. An attachment hoop 50 engages the web 48 and establishes a rigid, circular perimetric anchorage for the web 48 which enables the web 48 to be drawn taut.

Referring also to FIG. 6, a counterhoop 52 is provided to imposing force against the attachment hoop 50 to exert tension on the web 48. The counterhoop 52 may comprise a structural body 54 forming a ring having an internal opening 56 greater in diameter than the exterior diameter (shown as arrow 58 in FIG. 1A) of the drum shell 10. The counterhoop 52 bears openings spaced about the circumference of the counterhoop 52. Each one of these openings (such as the opening 64 seen in FIG. 6) is disposed to receive the shank of a fasteners such as the shank 60 of a tension key 62. The openings pass the shanks of the fasteners in a direction parallel to the axis 18 of the annular drum 10. The components listed thus far are present in conventional musical drums.

Referring to FIG. 1B, which shows only the drum shell 10 from the conventional drum depicted in FIG. 1A, a plurality of external lugs 20, 22, 24, 26, 28, 30 are fixed to the shell 10. Each one of the lugs 20, 22, 24, 26, 28 30 has a threaded hole 32, 34, 36, 38, 40, 42, each of which is axially oriented parallel to the axis 18 of the drum shell 10. The components listed thus far are present in conventional musical drums.

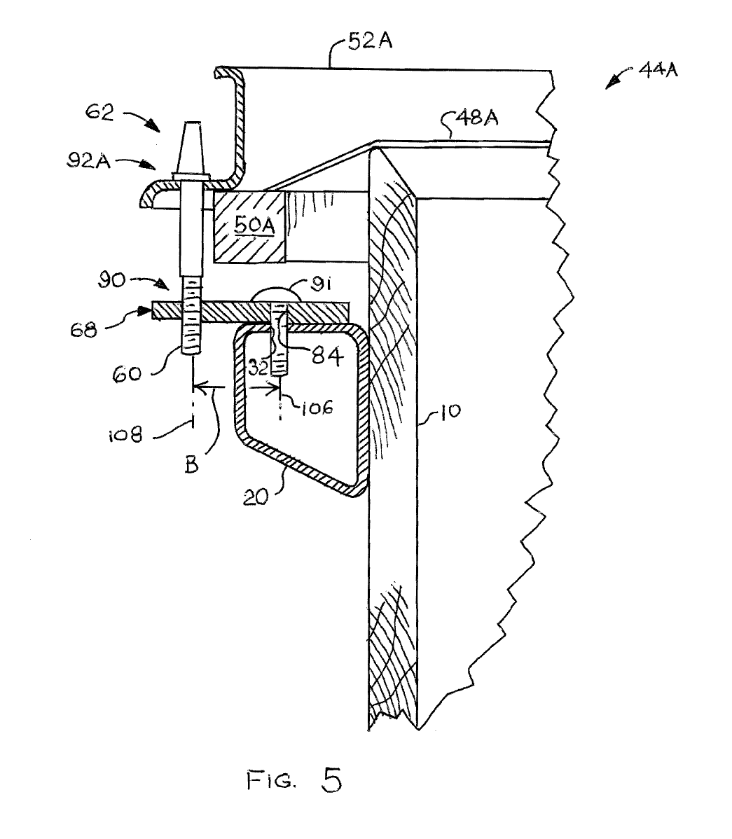

FIG. 1B shows novel adapting brackets 66, 68 which alter the geometry and nature of conventional drums to achieve improved acoustic performance. Turning momentarily to FIG. 3, the adapting bracket 68 is shown at greater scale and hence in greater detail than in FIG. 1B. The adapting bracket 68 may comprise a body in the form of a plate 70 having sufficient thickness to impart sturdiness and a length, an inner lateral surface 72 which is concavely curved along the length of the adapting bracket 68 or which is otherwise configured to cooperate with the outer surface of the drum shell 10, an opposed outer lateral surface 74, a first end 76 disposed between the inner lateral surface 72 and the opposed outer lateral surface 74, and a second end 78 disposed between the inner lateral surface 72 and the opposed outer lateral surface 74, and which is located in opposition to the first end 76.

The plate 70 may comprise a first inner hole 80 located proximate the first end 76 and the inner lateral surface 72, a second inner hole 82 located proximate the second end 78 and the inner lateral surface 72, and a third inner hole 84 located proximate the inner lateral surface 72, and between the first inner hole 80 and the second inner hole 82.

The plate 70 may have a first outer hole 86 located proximate the first end 76 and the outer lateral surface 74, a second outer hole 88 located proximate the second end 78 and the outer lateral surface 74, and a third outer hole 90 located proximate the outer lateral surface 84 and between the first outer hole 86 and the second outer hole 88.

The first inner hole 80, the second inner hole 82, and the third inner hole 84 are smooth walled and of greater diameter than the first outer hole 86, the second outer hole 88, and the third outer hole 88. Moreover, the first outer hole 86, the second outer hole 88, and the third outer hole 88 comprise threading which matches the threading of the threaded holes 32, 34, 36, 38, 40, 42 of the lugs 20, 22, 24, 26, 28, 30. The adapting bracket 66 may be similar to the adapting bracket 68.

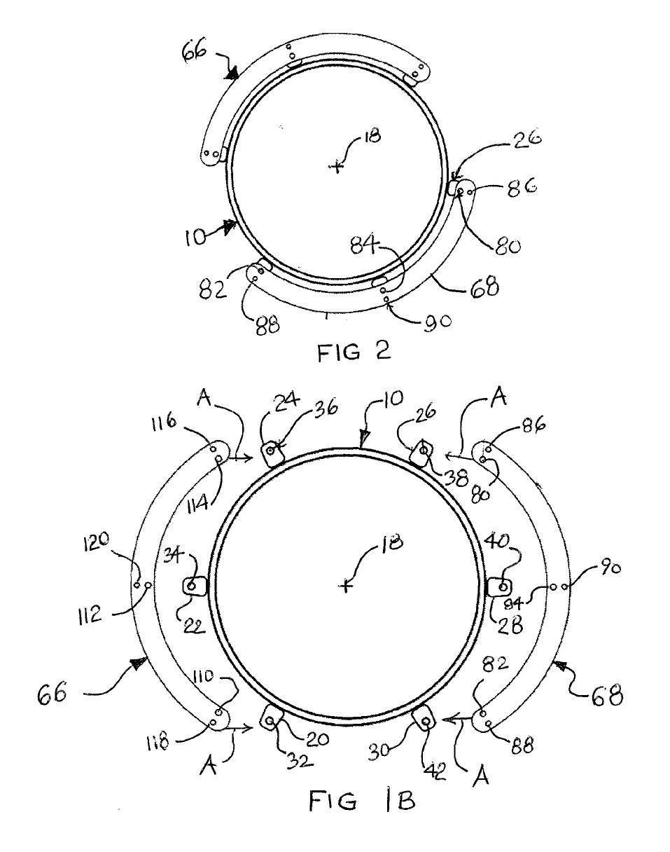

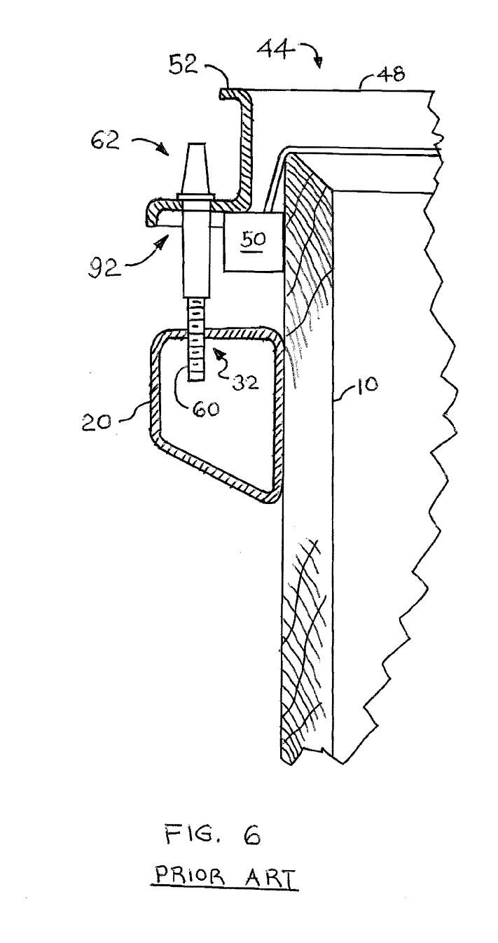

Referring also to FIG. 5, the arrangement of the hole pattern of the adapting brackets 66, 68 assures that the inner holes such as the inner holes 80, 82, 84 will be axially aligned with the threaded holes 32, 34, 36, 38, 40, 42 of the lugs 20, 22, 24, 26, 28, 30 when the adapting brackets 66, 68 are installed to the drum shell 10. FIG. 1B shows the drum shell 10 and the adapting brackets 66, 68 prior to installation. When installed, the adapting brackets 66, 68 are moved in the direction of the arrows A, and come to be positioned as seen in FIG. 2. The adapting brackets 66, 68 may then be fixed to the drum shell 10 by installing bolts or screws such as the screw 91 (see FIG. 5), or alternatively, any other fastener element which may be disposed to fix the adapter bracket 68 to the external lugs such as the lug 20 of the drum shell 10 by engaging the original threaded holes such as the threaded hole 32 of the external lugs.

This enables a drum head such as the drum head 44 to be placed over the drum shell 10 and secured thereto. However, the drum head selected for installation will be what may be regarded as an oversized drum head for the particular drum shell 10. Drum heads are available in nominal diameters in increments of one inch within the nominal diameter range of six to forty inches, which sizes account for a great majority of drums in use toda. This situation is readily apparent when comparing FIGS. 5 and 6. The original drum head 44 (FIG. 6) is replaced by a standard drum head 44A (FIG. 5) of the next greater nominal diameter. FIG. 6 shows the prior art drum assembly, wherein it will be seen that the counterhoop 52 is coupled to the lug 20 by passing the tension key 62 through a hole 92 of the counterhoop 52 and threading the shaft 60 of the tension key 62 into the hole 32 of the lug 20. Note that the attachment hoop 50 is in direct contact with the outer surface of the drum shell 10. This contact adversely affects tonal qualities of the drum.

However, and with reference to FIG. 5, with the hole pattern provided by the adapting brackets 66, 68, the oversized drum head 44A and the corresponding oversized counterhoop 52A are shown installed on the original drum shell 10. Displacement of the location of the tension keys such as the tension key 62 is indicated by arrow B, which represents the additional radial distance from the axis 106 of the threaded hole 32 to the axis 108 of the outer hole 90 of the adapting bracket 68.

The oversized attachment hoop 50A of the oversized drum head 44A is seen to be spaced away from the drum shell 10, thus eliminating a major source of adverse influences on tonal qualities of the drum.

It will be seen in FIG. 5 that the inner holes of the adapting bracket 68, such as the inner hole 84, axially aligns with the threaded hole 32 of the lug 20, thereby enabling the adapting bracket 68 to be mounted to the drum shell 10. The adapting bracket 68 provides holes for receiving the threaded shank of the tension keys such as the tension key 62, but at a greater radial distance from the axis 18 (FIG. 2) of the drum shell 10, thus accommodating the oversized replacement drum head 44A.

In summary, the arrangement of the hole pattern of the adapting brackets 66, 68 is such that when the inner holes such as the inner holes 80, 82, 84 are axially aligned with the threaded holes 32, 34, 36, 38, 40, 42 of the lugs 20, 22, 24, 26, 28, 30, the outer holes such as the outer holes 86, 88, 90 are axially alignable with the openings such as the opening 92A of the oversize counterhoop 52A. The function of the adapting brackets 66, 68 is then to enable the openings of the oversize counterhoop 52A to be located at radial distances from the axis 18 of the drum shell 10 which are greater than the radial distances of the threaded holes 32, 34, 36, 38, 40, 42 of the lugs 20, 22, 24, 26, 38, 30 from the axis 18. The superseding radial distances correspond to those of an oversize counterhoop such as the counterhoop 52A.

To perform their functions, each of the inner holes 80, 82, 84 of the adapting bracket 68 is smooth walled or otherwise configured to pass the shank of a tension key such as the tension key 62 in close cooperation therewith, while obstructing passage of the head of the tension key, and of greater diameter than the outer holes 86, 88, 90, since they must pass the threaded shaft of the fastener such as the screw 91. Each of the outer holes 86, 88, 90 of the adapting bracket 68 is threaded, and matches the dimensions and the threading of the threaded holes 32, 34, 36, 38, 40, 42 of the lugs 20, 22, 24, 26, 38, 30, so that the originally provided tension keys such as the tension key 62 may be reused.

Adapting brackets such as the adapting brackets 66, 68 may be formed from any suitable strong and rigid material, such as steel, aluminum, or brass, or a suitable plastic such as a thermoplastic polycarbonate resin of the type sold as Lexan® for example.

The invention may be thought of as a drum having an oversized drum head, as that concept has been described above, together with adapter brackets such as the adapter brackets 66, 68, which enable attachment of the oversized drum head to the drum shell. In another aspect, the invention may be thought of as the adapter brackets such as the adapter brackets 66, 68 which enables an oversized drum head such as the oversized drum head 52A to be operably fitted to a drum shell of a drum, such as the drum shell 10. According to still another aspect, the invention may be thought of as a method of converting a conventional drum to an improved drum wherein the attachment hoop such as the attachment hoop 50A is spaced apart from the drum shell such as the drum shell 10. The method of converting a conventional drum to an improved drum may start with the step of providing a conventional drum shell such as the drum shell 10, and removing the original standard size drum head if present. Another step is providing one or more adapter bracket which has attachment elements enabling the adapter bracket to be mounted to the lugs of the drum shell, and threaded holes located at radial distances from the axis of the drum shell which enable the tension keys to be threaded to the threaded holes of the adapter bracket when the adapter bracket is mounted to the lugs. This may be accomplished by providing the adapter brackets 66, 68 or functional substitutes therefore. A further step may be that of providing an oversized drum head and an oversized counterhoop having holes disposed to receive the tension keys. As mentioned prior, this may be accomplished by purchasing a standard drum head and counterhoop from ordinary retail outlets, where such items are readily available at reasonable cost. Another step may be that of installing the oversized drum head onto the drum shell. A further step may be that of securing the oversized drum head to the drum shell by installing the original tension keys in the oversize counterhoop and threading the tension keys to the threaded holes of the adapter bracket or functional substitute, such that the tension keys are located at a greater radial distance from the axis of the drum shell than the radial distance of the tension keys from the axis when the tension keys were mounted to the lugs of the drum shell. Web or skin tension may then be adjusted in conventional manner to produce desired acoustic characteristics.

It should be noted that adapter brackets according to the principles of the present invention may take forms other than the adapter brackets 66, 68 described herein. For example, a single circular adapter bracket (not shown) having the appropriate hole characteristics may be provided. In other examples predicated on the drum shell 10, three adapter brackets each having two inner holes and two outer holes could be provided. If desired, and referring to FIG. 4, adapter brackets such as an adapter bracket 96 could each be arranged to extend the effective radius of only one threaded hole of a lug such as the threaded hole 32, thereby enabling an oversized drum head to be operably fitted to the drum shell 10. The adapter bracket 96 may comprise a plate 98 having a length 100, an inner hole 102 located at one end of the plate, and an outer hole 104 located at an opposite end of the plate 96 along the length of the plate 96. The inner hole 104 is smooth walled and of greater diameter than the outer hole 102. The outer hole 102 comprises threading matching the threading of a threaded hole of a lug of a musical drum, such as the threaded hole 32 of the lug 20 (see FIG. 5).

It would also be possible to utilize an asymmetric arrangement of adapting brackets. The adapting brackets 66, 68 are seen as symmetrical in that each is essentially a mirror image of the other. The adapting bracket 66 has inner holes 110, 112, 114 and outer holes 116, 118, 120 which may be structural and functional equivalents of their similarly named counterparts of the adapting bracket 68.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A musical drum comprising:
an annular drum shell having an annular wall, a first open end, and an opposed second open end, an axis extending from the first open end to the opposed second open end and which is oriented concentrically within the annular wall, and a plurality of external lugs fixed to the shell and each having a threaded hole which is axially oriented parallel to the axis of the drum shell;
at least one first drum head comprising a web which is dimensioned and configured to close one of the first open end and the opposed second open end and to be drawn tightly into abutment with the annular drum shell, and an attachment hoop which engages the web and establishes a rigid, circular perimetric anchorage for the web;
a counterhoop comprising an internal opening greater in diameter than the exterior diameter of the drum shell, and which bears openings spaced about the circumference of the counterhoop, which said openings are disposed to receive shanks of fasteners in a direction parallel to the axis of the annular drum, wherein the openings of the counterhoop are located at radial distances from the axis of the drum shell greater than the radial distances of the threaded holes of the lugs from the axis of the drum shell; and
at least one adapting bracket comprising a plurality of inner holes and an equal number of outer holes arranged such that when the inner holes are axially aligned with the threaded holes of the lugs, the outer holes are axially alignable with the openings of the counterhoop.

2. The musical drum of claim 1, further comprising a second drum head having functional characteristics of the first drum head, and which is dimensioned and configured to close that one of the first open end and the opposed second open end which is not closed by the first drum head.

3. The musical drum of claim 1, wherein each of the inner holes of the adapting bracket is smooth walled and of greater diameter than the outer holes, and each of the outer holes of the adapting bracket is threaded, and matches the dimensions and the threading of the threaded holes of the lugs.

4. The musical drum of claim 1, wherein each said adapting bracket comprises a length, an inner lateral surface which is concavely curved along the length of the bracket, an opposed outer lateral surface, a first end disposed between the inner lateral surface and the opposed outer lateral surface, a second end disposed between the inner lateral surface and the opposed outer lateral surface and located in opposition to the first end, a first inner hole located proximate the first end and the inner lateral surface, a second inner hole located proximate the second end and the inner lateral surface, a first outer hole located proximate the first end and the outer lateral surface, and a second outer hole located proximate the second end and the outer lateral surface, wherein the first inner hole and the second inner hole are smooth walled and of greater diameter than the first outer hole and the second outer hole, and wherein the first outer hole and the second outer hole comprise threading matching the threading of the threaded holes of the lugs.

5. The musical drum of claim 4, wherein each said adapting bracket comprises
a third inner hole located proximate the inner lateral surface and between the first inner hole and the second inner hole, and
a third outer hole located proximate the outer lateral surface and between the first outer hole and the second outer hole, wherein
the third inner hole is smooth walled and of greater diameter than the third outer hole, and the third outer hole comprises threading matching the threading of the threaded holes of the lugs.

6. The musical drum of claim 1, further comprising a fastener element disposed to fix the adapter bracket to the external lugs of the drum shell by engaging the threaded holes of the external lugs.

7. An adapter bracket for enabling an oversized drum head to be operably fitted to a drum shell of a drum comprising a drum head, a counterhoop, and a drum shell having lugs each bearing a threaded hole, comprising:
a body having a length, with an inner lateral surface and an opposed outer lateral surface;
a shell mounting structure disposed proximate said inner lateral surface; and
a drum head mounting structure disposed proximate said outer lateral surface, such that said adapter bracket allows for the oversized drum head to be operably fitted to a drum shell.

8. The adapter bracket of claim 7, wherein the outer lateral surface is configured to cooperate with the outer surface of the drum shell.

9. The adapter bracket of claim 7, wherein the shell mounting structure comprises at least a first inner hole located proximate the inner lateral surface and a second inner hole located proximate the inner lateral surface and wherein the first inner hole and the second inner hole are dimensioned and configured to pass the shank of a tension key in close cooperation therewith.

10. The adapter bracket of claim 7, wherein the drum head mounting structure comprises at least a first outer hole located proximate the outer lateral surface, and a second outer hole located proximate and the outer lateral surface, wherein the first outer hole and the second outer hole each comprise threading matching the threading of the threaded holes of the lugs.

11. The adapter bracket of claim 7, further comprising
a third inner hole located proximate the inner lateral surface and between the first inner hole and the second inner hole: and
a third outer hole located proximate the outer lateral surface and between the first outer hole and the second outer hole, wherein the third inner hole is configured to are dimensioned and configured to pass the shank of a tension key in close cooperation therewith, and the third outer hole comprises threading matching the threading of the threaded holes of the lugs.

12. The adapter bracket of claim 7, wherein the inner lateral surface of the body of the bracket is arcuate.

13. A method of converting a conventional drum having a drum shell bearing external lugs and having an axis, a drum head including an attachment hoop, and a counterhoop, and tension keys having threaded shanks to an improved drum wherein the attachment hoop is spaced apart from the drum shell, comprising the steps of:
providing a drum shell having a plurality of lugs and a plurality of tension keys;
providing an adapter bracket which has attachment elements enabling the adapter bracket to be mounted to the lugs of the drum shell, and threaded holes located at radial distances from the axis of the drum shell which enable the tension keys to be threaded to the threaded holes of the adapter bracket when the adapter bracket is mounted to the lugs;
providing an oversized drum head and an oversized counterhoop having holes disposed to receive the tension keys;
installing the oversized drum head onto the drum shell; and
securing the oversized drum head to the drum shell by installing the tension keys in the oversize counterhoop and threading the tension keys to the threaded holes of the adapter bracket, such that the tension keys are located at a greater radial distance from the axis of the drum shell than the radial distance of the tension keys from the axis when the tension keys were mounted to the lugs of the drum shell.
